(19) United States
(12) Patent Application Publication
(10) Pub. No.: US 2014/0065426 A1
(43) Pub. Date: Mar. 6, 2014

(54) METHOD FOR MANUFACTURING A TRANSPARENT CONDUCTIVE FILM LAMINATE AND A TRANSPARENT CONDUCTIVE FILM LAMINATE

(71) Applicant: National Institute of Advanced Industrial Science And Technology, Tokyo (JP)

(72) Inventors: Masatou ISHIHARA, Tsukuba-shi (JP); Takatoshi YAMADA, Tsukuba-shi (JP); Yoshinori KOGA, Tsukuba-shi (JP); Masataka HASEGAWA, Tsukuba-shi (JP); Jaeho KIM, Tsukuba-shi (JP)

(73) Assignee: National Institute of Advanced Industrial Science And Technology, Tokyo (JP)

(21) Appl. No.: 14/071,858

(22) Filed: Nov. 5, 2013

Related U.S. Application Data
(63) Continuation of application No. PCT/JP2012/061539, filed on May 1, 2012.

(30) Foreign Application Priority Data
May 6, 2011 (JP) 2011-103370

(51) Int. Cl. H01B 13/00; H01B 1/04

(52) U.S. Cl. CPC H01B 13/0036; H01B 1/04
USPC 428/408; 156/247

(57) ABSTRACT

The invention addresses the problem of prior methods, which formed a binder layer on a graphene film, that the shape of the substrate surface was transferred to the graphene layer. The purpose is to provide a technique for forming less cloudy, highly transparent conductive film laminates. The invention solves the problem, in methods that manufacture transparent conductive carbon films by forming a transparent conductive carbon film on a film forming substrate using the CVD method and then removing said film forming substrate from said transparent conductive carbon film, by preparing a film having an adhesive surface and providing a process of gluing the adhesive surface of said film to a portion and/or all of the surface of the transparent conductive carbon film prior to removal of the film forming substrate.

### CROSS REFERENCE TO RELATED APPLICATIONS

This application is based upon and claims the benefit of priority from the prior Japanese Patent Application No. 2011-103370, filed on May 6, 2011, and PCT Application No. PCT/JP2012/061539, filed on May 1, 2012, the entire contents of which are incorporated herein by reference.

### FIELD

The present invention relates to a method for producing a transparent conductive film laminate for use in a touch panel etc. and a transparent conductive film laminate.

### BACKGROUND

Planar crystals having conductivity by SP2 bonded carbon atoms are called “graphene”. Graphene is described in detail in Kumi Yamada, Chemistry and Industry, 61 (2008) pp. 1123-1127. Graphene is a basic unit of a crystalline carbon film of various forms. Examples of crystalline carbon films using graphene are single-layer graphene made from one layer of graphene, nano-graphene which is a laminate of about several layers to tens of layers of nanometer-sized graphene, and carbon nanowalls in which a graphene laminate of about several layers to tens of layers stack is oriented at an angle nearly perpendicular to a substrate surface (Refer to Y. Wu, P. Qiao, T. Chong, Z. Shen, Adv. Mater. 14 (2002) pp. 64-67).

A crystalline carbon film using graphene is expected to be used as a transparent conductive film and a transparent electrode given its high light transmittance and electrical conductivity. Furthermore, carrier mobility of electrons and holes within graphene has the potential to be a maximum of 200,000 cm²/Vs, 100 times greater than silicon at room temperature. Development of ultra-high-speed transistors with the aim of terahertz (THz) operations by taking advantage of the characteristics of graphene is progressing.

Manufacturing methods of graphene until recently such as a separation method from natural graphite, a desorption method of silicon using a high-temperature heat treatment of silicon carbide, and a formation method to a variety of metal surfaces have been developed. However, a transparent conductive carbon film using a crystalline carbon film from graphene has been examined for a wide range of industrial uses and therefore, a deposition method over a large area is desired at a high throughput.

Recently, a method for forming graphene using a chemical vapor-phase synthesis method (CVD) on a copper foil surface has been developed (Xuesong Li, Weiwei Cai, Jinho An, Seyoung Kim, Junghyo Nah, Dongxing Yang, Richard Piner, Aruna Velamakanni, lnhwa Jung, Emanuel Tutuc, Sanjay K. Banerjee, Luigi Colombo, Rodney S. Ruoff Science, Vol. 324, 2009, pp. 1312-1314, and Xuesong Li, Yanwu Zhu, Weiwei Cai, Mark Borysiak, Boyang Han, David Chen, Richard D. Piner, Luigi Colombo, Rodney S. Ruoff, Nano Letters, Vol. 9, 2009, pp. 4359-4363). A graphene deposition method which uses the copper foil as a substrate is a thermal CVD method in which methane gas as a raw material gas is thermally decomposed at about 1000° C. to form graphene having one layer to several layers on the surface of the copper foil.

Manufacturing the graphene film using the thermal CVD method is a high-temperature process with a synthesis temperature of about 1000° C. and a long process time which was a problem. The inventors of the present invention realized a method of forming a transparent conductive carbon film using the crystalline carbon film formed using a graphene film in a short time at a lower temperature by using a microwave using a surface wave microwave plasma on a copper foil substrate and create a sample of a touch panel using a large-area transparent conductive carbon film (Jaeho Kim, Masatou Ishihara, Yoshinori Koga, Kazuo Tsugawa, Masataka Hasegawa, Appl. Phys. Lett., 98 (2011) pp. 091502_{—}1-091502_{—}3).

A graphene film using a thermal CVD method is formed on a catalyst metal and in this state cannot be used for touch panel applications. Therefore, in Japan Patent Publication No. 2009-298683 a technology is proposed in which after forming a binder layer on a graphene sheet formed on the catalyst metal and fixing the graphene sheet to a substrate such as PET, the catalytic metal from the graphene sheet is dissolved and removed using an etching solution such as acid and thereby a graphene sheet is formed on the substrate.

### SUMMARY

In the thermal CVD method described above, a catalytic metal substrate is required for synthesizing a transparent conductive carbon film using the crystalline carbon film formed by a graphene film and in recent years copper foil is often used. In the method for manufacturing copper foil, there are two types of rolling process and electrolytic process. However, the copper foil manufactured by either process suffers from irregularities relating to manufactured foil such as rolling marks or electrodeposition drum marks occur.

These irregularities are not limited to the copper foil used as a catalytic metal substrate. The same is also true in the case where other metals such as aluminum and nickel are used as a film forming substrate. In addition, because a graphene film formed on the film forming substrate is comprised of a single-layer graphene formed from one later of graphene, or nano-graphene in which nanometer sized graphene is stacked in several to several tens of layers, the film thickness of the graphene film is very small compared with the irregularities of the film-forming substrate.

Therefore, in the case where a graphene film is synthesized using a substrate with irregularities, as the method described in Japan Patent Publication No. 2009-298683, when the graphene film is formed directly into a film by coating a binder material, the copper foil irregularities are also transferred and cause haze which leads to a decrease in film transparency.

FIG. 1 is a schematic diagram which shows a step (b) of forming the graphene film (101) on a catalyst metal substrate (100) such as copper foil described above, a step (c) of forming a binder layer (102) on the graphene film by coating a binder material, and a step (d) of removing the catalyst metal substrate.

As is shown in FIG. 1, in the case where there are irregularities on the catalytic metal substrate (100), when the graphene film (101) is formed on the catalyst metal substrate (100), the graphene film is also formed following the uneven shape of the irregularities (b). In the methods described above, because a binder layer such as an acrylic resin is coated on the graphene film in the state of having irregular shapes and cured, irregularities of the catalytic metal substrate are also transferred to the binder layer after curing, and thereby irregularities also remain on the graphene film (c).

In Japan Patent Publication No. 2009-298683 described above, a method of using a graphene film in the state where the catalytic metal substrate (100) is removed by dissolving (d), or removing the binder layer (102) by dissolving and transferring to another substrate such an element has been proposed. However, the graphene film which is fixed to the binder layer (102) not only maintains the irregularities which reflect the irregularities of the catalytic metal substrate (d), but there are problems as the irregularities also remain on the graphene film even when it is transferred to another substrate such as an element and as the binder layer is leftover in the gaps between the irregular shape. As a result, transparency of the transfer substrate decreases and haze may occur.

The present invention was made in view of the above circumstances, and aims to provide a method of solving the problem of irregularities on a substrate surface being transferred to the graphene layer which is the problem in the method of forming a binder layer on a conventional graphene film, and to provide a method for forming a transparent conductive film laminate having high transparency and less haze.

The present inventors, found a new method using an adhesive tape as a result of keen examination in order to achieve the above aims, and judged that it is possible to form a transparent conductive film laminate using a carbon film with high transparency and less haze compared with the conventional method and thereby solve the above described problems in the conventional technology.

Based on these findings, the present invention was completed as follows:

(1) A method for manufacturing a transparent conductive carbon film by forming the transparent conductive carbon film by a CVD method on a film forming substrate and subsequently removing the film forming substrate from the transparent conductive carbon film, the method including preparing a film having a surface with adhesive strength and bonding a surface with adhesion strength of the film to all or a part of a surface of the transparent conductive carbon film before removing the film forming substrate.
(2) The method for manufacturing a transparent conductive carbon film according to (1), includes adding pressure to the film after bonding an adhesion surface of the film to the surface of the transparent conductive carbon film.
(3) The method for manufacturing a transparent conductive carbon film according to (1) or (2), includes performing pressing at the same time as bonding the adhesion surface of the film to the surface of the transparent conductive carbon film using a pressure roller.
(4) The method for manufacturing a transparent conductive carbon film according to any one of (1) to (3), includes transferring the transparent conductive carbon film to another transfer material.
(5) The method for manufacturing a transparent conductive carbon film according to any one of (1) to (4), includes forming the transparent conductive carbon film into a pattern.
(6) The method for manufacturing a transparent conductive carbon film according to (5), wherein the forming into a pattern is performed on the transparent conductive carbon film formed on the film forming substrate using a CVD method.
(7) The method for manufacturing a transparent conductive carbon film according to (6), wherein the forming into a pattern uses an object having a patterned surface with adhesion strength as the film for bonding.
(8) The method for manufacturing a transparent conductive carbon film according to any one of (1) to (7), wherein the film forming substrate is a copper substrate.
(9) The method for manufacturing a transparent conductive carbon film according to any one of (1) to (8), wherein the transparent conductive carbon film is a graphene film.
(10) A transparent conductive carbon film laminate manufactured using the manufacturing method of the transparent conductive carbon film according to any one of (1) to (9).

### BRIEF DESCRIPTION OF THE DRAWINGS

FIG. 1 is a diagram schematically showing a step of forming a graphene film on catalytic metal substrates such as copper foil (b), coating a binder material and forming a binder layer on the graphene film (c) and removing the catalyst metal substrate (d);

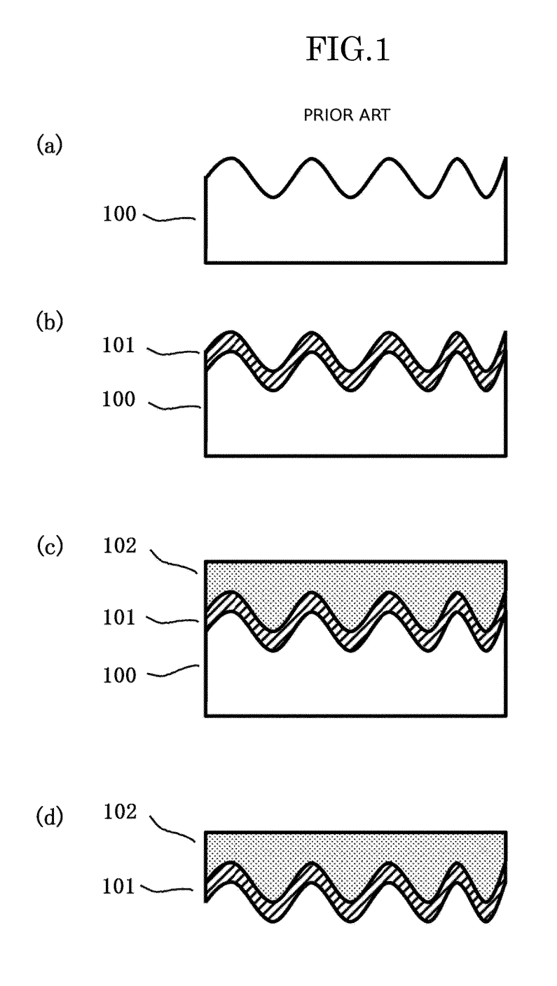

FIG. 2 is a schematic diagram showing a film forming substrate and transparent conductive carbon film formed on the substrate of the present invention;

FIG. 3 is a cross-sectional view schematically showing a surface wave microwave plasma device used to form a transparent conductive carbon film;

FIG. 4 is a schematic diagram showing an example of a structure of a film having a surface with adhesive strength in the present invention;

FIG. 5 is a schematic diagram showing a step of bonding a film having a surface with adhesive strength to at least a part of the transparent conductive carbon film formed by a CVD method on irregularities on the surface of the film forming substrate in the present invention;

FIG. 6 is a schematic diagram showing a step of pressing a film having a surface with adhesive strength to at least a part of the transparent conductive carbon film formed by a CVD method on irregularities on the surface of the film forming substrate in the present invention;

FIG. 7 is a schematic diagram showing a step of performing a pressing process at the same time as bonding an adhesive surface of a film using a pressure roller and a surface of the transparent conductive carbon film in the present invention;

FIG. 8 is a schematic diagram showing a transparent conductive film laminate comprising a film (302) having a surface with adhesive strength after the film-forming substrate is removed and a smooth transparent conductive carbon film (304);

FIG. 9 is a schematic diagram showing a transparent conductive film laminate manufactured by transferring the smooth transparent conductive carbon film (304) to another transfer material (305) in one exemplary embodiment of the present invention;

FIG. 10 is a schematic diagram showing a cross section of touch panel manufactured by stacking and bonding electrodes formed on a film having a surface with adhesive strength in one exemplary embodiment of the present invention; and

FIG. 11 is a sample product photograph of a touch panel formed by patterning the transparent conductive film laminate manufactured in Example 3.

### DESCRIPTION OF EMBODIMENTS

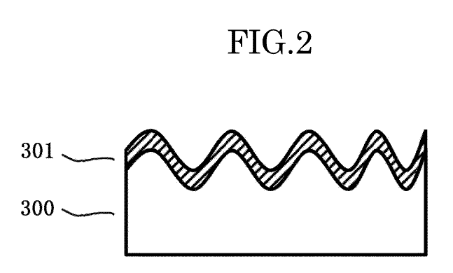

The present invention is described below while referring to the drawings. FIG. 2 is a schematic diagram showing a film forming substrate (300) and a transparent conductive carbon film (301) of the present invention formed on the substrate. As is shown in FIG. 2, the transparent conductive carbon film is formed following the irregular shape on the surface of the film forming substrate and as a result, the transparent conductive carbon film having an irregular shape on the surface is formed.

At least one type of metal selected from copper (Cu), iron (Fe), nickel (Ni), aluminum (Al) etc., can be used as the film forming substrate. In addition, the film thickness of the substrate is between around 1 nm and 10 mm, and more preferably a thin film or foil with a thickness of between 500 nm and 0.1 mm is preferably used.

A CVD method is used as a method for forming a transparent conductive carbon film composed of a graphene film on a film forming substrate, for example, a thermal CVD method of introducing a raw material gas in the presence of a catalyst metal and performing thermal decomposition of the raw material gas, and a surface wave microwave plasma chemical vapor deposition (CVD) method which performs a treatment process using a microwave plasma are available.

In order to perform a CVD process for forming a transparent conductive carbon film without changing the surface shape of the film-forming substrate and causing evaporation of the catalytic metal substrate, it is necessary to process at sufficiently lower temperatures than the melting point of the film forming substrate (for example the melting point of copper is 1080° C.).

A typical microwave plasma CVD process is performed at a pressure of 2×10³ to 1×10⁴ Pa. The plasma does not diffuse well under the pressure and because the plasma concentrates in a narrow region, the temperature of the neutral gas in the plasma becomes 1000° C. or more. Consequently, the copper foil substrate is heated to a temperature of 800° C. or more and evaporation of copper from the substrate increases. Therefore it cannot be applied in the manufacture of a carbon film. In addition, there is a limit to evenly spreading the plasma region and formation of a carbon film having a high uniformity is difficult over large areas.

Therefore, a plasma treatment at a lower pressure is required in order to form a transparent conductive carbon film having a high uniformity over a large area while maintaining a low temperature of the film-forming substrate during film formation.

In the following examples, a surface wave microwave plasma device which can generate and maintain a plasma stably at 10² Pa or less was used in for the formation of the transparent conductive carbon film. A surface wave microwave plasma is described in detail for example in the document “Hideo Sugai, Plasma Electronics, Ohm' Company, 2000, p. 124-125”.

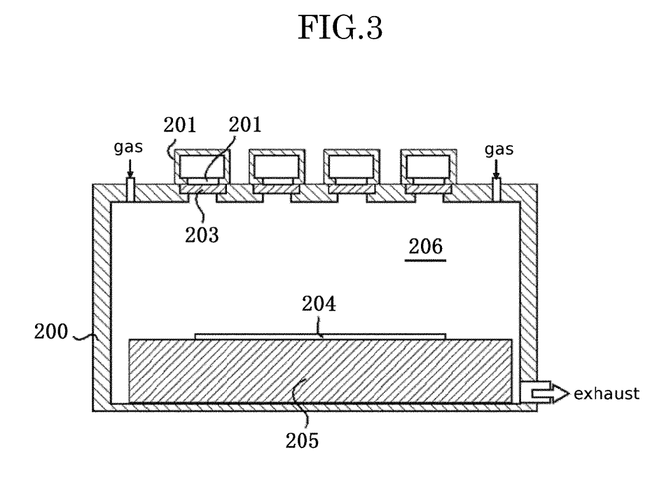

FIG. 3 is a cross-sectional diagram showing a schematic view of the surface wave microwave plasma device used. In FIG. 3, 200 is a discharge container, 201 is a rectangular waveguide, 202 is a slot antenna, 203 is a quartz window, 204 is a substrate, 205 is a sample base and 206 is a reaction chamber respectively.

In this way, it was possible to generate obtain a sufficiently lower temperature than the melting point of the film-forming substrate and generate a uniform plasma over a large area of 380 mm×340 mm or more. As a result of a diagnosis of the plasma using a Langmuir probe method (single-probe method), the electron density was 10¹¹ to 10¹²/cm³, the cut-off electron density exceeded 7.4×¹⁰/cm³ with respect to a microwave frequency of 2.45 GHz and the surface wave plasma generated and maintained from the surface waves was confirmed. The Langmuir probe method is described in detail, for example, in the document “Hideo Sugai, Plasma Electronics, Ohm Company, 2000, p. 58”.

As the conditions of the CVD process used in the present invention, the substrate temperature is at 500° C. or less, preferably 50 to 500° C. and more preferably 50 to 450° C. In addition, a pressure of 50 Pa or less, preferably 2 to 50 Pa, and more preferably 5 to 20 Pa is used.

The processing time is not particularly limited. However, about 1 to 600 seconds and about 1 to 60 seconds is preferable. If a processing time of this extent is used a carbon film having electrical conductivity and high light transmittance is obtained.

A raw material gas (reaction gas) used in the surface wave microwave plasma CVD process is a carbon-containing gas or a gas mixture comprised of a carbon-containing gas and an inert gas. Methane, ethanol, acetone, methanol and the like are included as the carbon-containing gas. Helium, neon and argon etc. are included as the inert gas. In the carbon-containing gas or the mixed gas comprised of the carbon-containing gas and the inert gas, the concentration of the carbon-containing gas is 30 to 100 mol % and preferably 60 to 100 mol %. When the carbon-containing gas is less than this range, problems such as a reduction of the electrical conductivity of the carbon film occur.

In addition, it is preferred that an oxidation inhibitor for inhibiting the oxidation of the surface of the substrate be used as an additive gas to the carbon-containing gas or gas mixture. Hydrogen gas is preferably used as the additive gas since it acts as an oxidation inhibitor of the substrate surface in the CVD process and displays an effect of promoting formation of a carbon film with high electrical conductivity. The added amount of hydrogen gas to the carbon-containing gas or gas mixture is preferably 1 to 30 mol %, and more preferably 1 to 20 mol %.

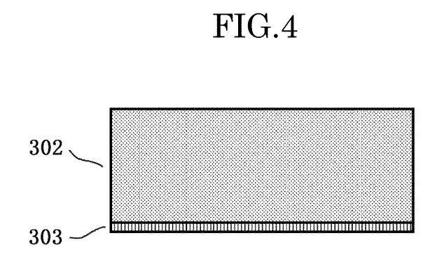

FIG. 4 is a schematic diagram which shows an example of the structure of a film (also referred to simply as “adhesive film” below) having a surface with adhesive strength of the present invention.

The surface with adhesive strength may be arranged on at least one surface of the film (302) and in the case where there is adhesive strength on one surface as in the example shown in the FIG. 4, it is desirable that this adhesive surface be covered by a peelable protective material (peeling liner) (303) to prevent dust unintended foreign matter from adhering to the adhesive surface. When adhering, the peeling liner (303) is peeled off. The thickness of the adhesion film (302) is from 1 μm to 1 mm, preferably from 20 μm to 1 mm. In addition, the thickness of the peeling liner (303) is preferred to be from 1 μm to 0.5 mm.

Although the adhesion film is not particularly limited, for example, siloxane (polydimethylsiloxane), acrylic (such as acrylic acid ester copolymer), rubber (such as synthetic rubber), urethane (such as urethane resin) can used to for, all or one part of the adhesion film.

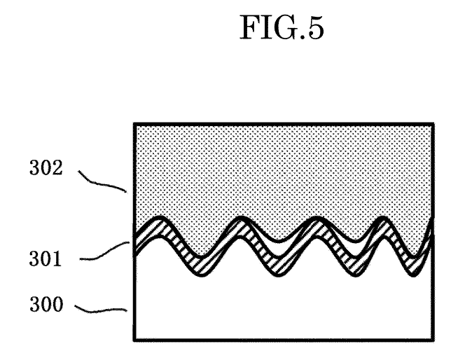

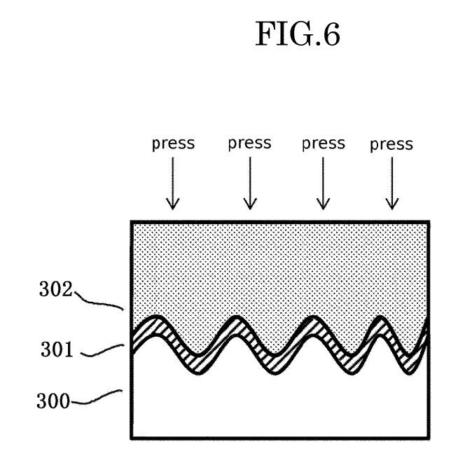

FIG. 5 and FIG. 6 are schematic views showing a step of bonding the adhesion film (302) to at least a part of a transparent conductive carbon film (301) formed by a CVD method on irregularities on the surface of the film-forming substrate (300).

The adhesive surface of the adhesion film (302) is bonded with the transparent conductive carbon film (301), and bonded on the opposite side of film-forming substrate (300). When bonding the adhesion film (302) and the transparent conductive carbon film (301) formed on the film forming substrate (300), as shown in FIG. 5, when air bubbles or foreign matter enter the adhesive surface the transparent conductive carbon film will not adhere thereon.

Therefore, it is essential to carefully perform adhesion so that air bubbles or foreign matter do not enter the surface and preferably apply pressure as shown in FIG. 6.

In addition, although it is necessary to uniformly press the adhesion film (302) to the transparent conductive carbon film (301) formed on the film forming substrate in order to form a transparent conductive film laminate bonded uniformly, in order to press uniformly, it is preferred to rotate and press with an equal force using a rubber roller with a length longer than the width of the transparent conductive carbon film (302) and the adhesion film (301).

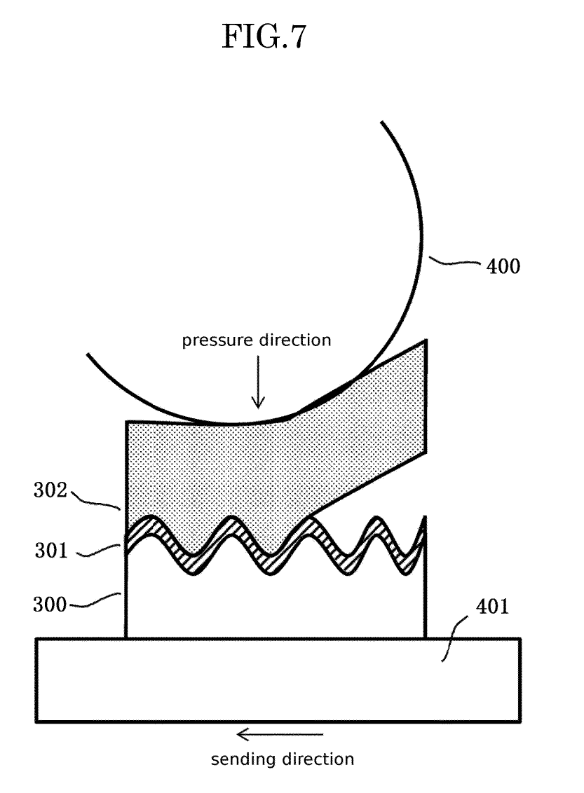

FIG. 7 exemplifies a method of this pressing method and is a schematic view showing a step for performing pressing at the same time as bonding the adhesive surface of the adhesion film (302) and the surface of the transparent conductive carbon film (301) using a pressure roller.

In order to form a transparent conductive film laminate having a uniform transparent conductive carbon film, it is necessary to uniformly bond the transparent conductive carbon film (301) formed on the film forming substrate with the adhesion film (302) and press. To press uniformly, first the film forming substrate formed with the transparent conductive carbon film is fixed to a smooth stage (401) with a surface larger than the film forming substrate, and after sticking one end of the adhesion film and one end of the film forming substrate together so that the graphene film is on the inside, a rubber pressure roller (400) with a length longer than the width of the adhesion film is rotated while pressing with equal force from the top, the stage is sent in a direction perpendicular to the pressure roller, and thus bonding and pressing are performed simultaneously. The film forming substrate and adhesion film formed with the transparent conductive carbon film may be vertically reversed with the adhesion film being fixed to the stage. In this way it is possible to keep mixing of air bubbles and foreign matter to a minimum.

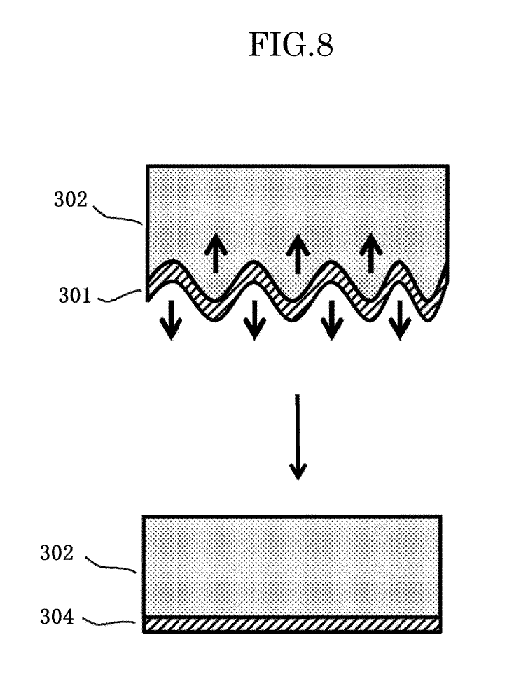

FIG. 8 is a schematic view showing a state in which the transparent conductive carbon film (301) having an irregular shape changes to a smooth transparent conductive carbon film (304) when the film forming substrate is removed in the present invention.

As shown in FIG. 8, at least one part of the adhesion film (302) is elastically deformed following the irregular shape on the film forming substrate due to its adhesive strength and the irregular shape of the film forming substrate is maintained. However, when the film forming substrate is removed, the film is released from the constraint of the substrate and attempts to return to its original shape by its elastic force. The transparent conductive carbon film is very thin compared to the adhesion film and the adhesive film is not prevented from returning to its original shape. As a result, the transparent conductive carbon film having an irregular shape deforms together with the adhesion film and a smooth transparent conductive carbon film (304) is obtained.

A method of etching, such as wet or dry etching, can be used in order to remove the film forming substrate. In wet etching, a method of immersing a laminate in which the adhesive film (302) is adhered to the transparent conductive carbon film (301) formed on the film forming substrate in acids or corrosion solution (such as a ferric chloride aqueous solution and an ammonium chloride aqueous solution) as an etchant, as shown in FIG. 6 above. In wet etching, because there is a possibility of inducing peeling from of the adhesive sheet of the transparent conductive carbon film when gas is generated during etching, it is necessary to avoid an etchant in which gas may be generated.

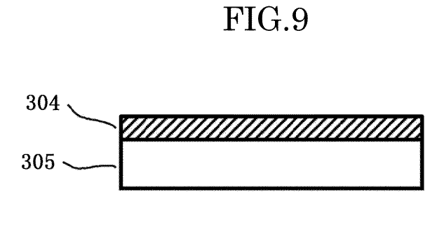

FIG. 9 is a schematic view showing the transparent conductive film laminate fabricated by transferring the smooth transparent conductive carbon films (304) to a different transfer material (305) in an exemplary embodiment of the present invention.

The transfer material (305) is a substrate characterized by a stronger interaction force between the transfer surface and the transparent conductive carbon film (301) than the interaction force between the transparent conductive carbon film (301) and the adhesive sheet (302). The transfer material (305) may have a strong interaction force in itself, the transfer material may also provide an interaction force by processing of the surface. Processing of the surface can include a method of coating a hardening resin, melting of the surface and formation of a microstructure, but the method is not limited to these.

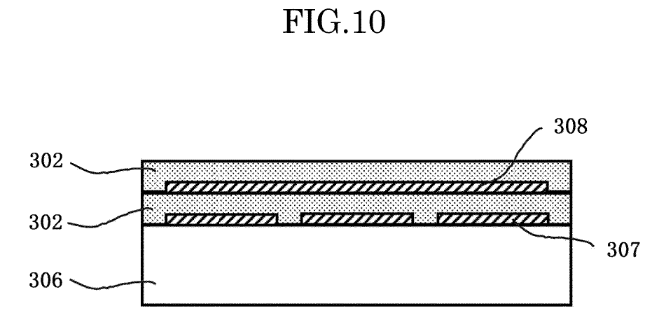

In addition, FIG. 10 is a schematic diagram showing one example having a step for forming a transparent conductive carbon film in a pattern shape in an exemplary embodiment of the present invention.

This structure is an example of a cross-sectional schematic view of a capacitive coupling type touch panel in which a lower electrode (307) and an upper electrode (308) of a touch panel are formed on a substrate (306) having a high transparency. The lower and upper electrodes have an electrode shape of one pair of operating capacitive coupling type touch panels. Although the following two methods are exemplified for manufacture of the electrodes, the method is not limited as long as similar electrodes are produced.

First, the film forming substrate (300) formed with the transparent conductive carbon film (301) is cut into an electrode shape. A method of cutting using a knife, stamping out using a mold patterned in the electrode shape, or cutting using a laser cutting process technique can be used. The film forming substrate formed with the transparent conductive carbon film which was cut into the shape of an electrode is pressed so that graphene surface is on the inside of the adhesion film (302) having the cross-sectional structure shown in FIG. 4. The film forming substrate on the adhesion film is removed and the conceptual structure of the transparent conductive film laminate shown in FIG. 8 is obtained.

After sufficiently washing the adhesion film with the transparent conductive carbon film patterned into the shape of an electrode, and dried, the upper electrode or lower electrode of the touch panel with the transparent conductive carbon film patterned into the shape of an electrode shape on the adhesion film is fabricated.

The lower electrode and upper electrode can be bonded and laminated to another substrate (306) or lower electrode as long as there is adhesion strength on at least one of their surfaces, and it is essential that care be taken to perform adhesion so that air bubbles or foreign matter do not enter.

In addition, there is another method for forming the patterned transparent conductive carbon film (301) on the adhesion film (302). First, the adhesive film attached with the peeling liner (303) is prepared. This is cut so that only the peeling liner is cut into the shape of an electrode using a knife or laser cutting process. The part of the peeling liner which forms the transparent conductive carbon film is peeled and removed to expose the adhesive surface. The patterned adhesion film and the film forming substrate (300) formed with the transparent conductive carbon film (301) are pressed so that the graphene surface is on the inside. At this time, it is essential that care be taken so that air bubbles or foreign matter do not enter. Furthermore, it is also essential that the entire adhesion surface which is processed into an electrode shape is covered by the transparent conductive carbon film by sufficient pressing.

After removing the film forming substrate from the laminate comprised of the adhesion film (302), the peeling sheet (303) and film forming substrate (300) formed with the transparent conductive carbon film (301) by etching, sufficiently washing and drying, when the peeling sheet is peeled and removed, it is possible to obtain a transparent conductive film laminate patterned with an electrode shape on the adhesive film.

Although the present invention is explained based on the following Examples, the present invention is not limited to these Examples.

First, an evaluation method used in the examples is explained.

(Optical Properties Measurement)

The optical properties of the transparent conductive film laminate prepared by the method of the present invention were measured. Two optical characteristics, haze (haze value) and the total light transmittance required for applications such as touch panels, were evaluated. The optical property measurement devices used were a haze meter (NDH5000) manufactured by Nippon Denshoku Industries Co., Ltd., the light source was a white LED and the measurement light beam had a diameter of 14 mm. First, the measurement system was calibrated in a state where nothing is placed on the sample stage and next a measurement of the transparent conductive film laminate was taken. The measurement and analysis was performed used an accompanying control unit (CU1) according to Japanese Industrial Standards. The Japanese Industrial Standards that were adopted were total light transmittance (Plastics—Test methods of total light transmittance of transparent materials—part one single beam method and compensation method (JIS K 7361)) and haze level (plastic—determination method of haze in a transparent material (JIS K 7136)).

haze=diffusion light intensity/total light beam transmitted light intensity×100(%)

(Measurement of Surface Roughness)

Measurement of surface roughness was performed using a fine shape measuring instrument (Kosaka Research Laboratory Ltd. Surfcorder ET4300) and the results were expressed by an arithmetic average roughness (Ra).

### Example 1

A transparent conductive carbon film (graphene film) was formed on a 33 μm thick A4 paper size rolled copper foil using a surface wave microwave plasma device shown in FIG. 3 as follows.

The height of a sample stage (205) was adjusted so that the distance between a quartz window (203) and the rolled copper foil which is a substrate (204) became 130 mm. Methane gas 30 SCCM, argon gas 20 SCCM, and hydrogen gas 10 SCCM were used as the plasma CVD gas. The gas pressure in the reaction container was held at 3 Pa using a pressure adjustment valve connected to an exhaust pipe. A plasma was generated using 18 kW of microwave power, and the plasma CVD process was carried out for 60 seconds to a copper foil substrate. A graphene film was fabricated on the A4 size rolled copper foil having a cross-sectional structure as in the conceptual diagram shown in FIG. 2 using the plasma CVD process described above. The arithmetic average roughness (Ra) of the rolled copper foil surface formed with the graphene film was 139 nm. The irregular shape is due to unevenness of the rolled copper foil because the film thickness of the graphene sheet was 1 nm or less.

Next, using an A4 sized siloxane-based adhesion film (Nitto Denko Co., Ltd. E-MASK DW100, adhesion: 2.04 gf/25 mm) having adhesion on only one surface, after removing the peeling liner (see 303 in FIG. 4) from the siloxane-based adhesion film, the peeling liner was bonded to the graphene film formed on the rolled copper foil. At this time, pressing was performed at a bonding pressure of 2.04 kgf/cm² using a film bonder (Suntec Co. Ltd. TMS-SAP) so that bubbles do not enter the film (see FIG. 7). The arithmetic average roughness (Ra) of the siloxane-based adhesion film surface which was used was 17 nm, and the film thickness was 40 μm. In this way, the surface of the adhesive film (302) has a very smooth surface shape compared to the film forming substrate (300).

The rolled copper foil was removed by etching in 5 wt % of ferric chloride and washed thoroughly with ion-exchange water. By drying the film using a warm-air drier at 50° C., a graphene laminate fixed to the adhesive film was obtained.

An epoxy resin (Nissin Resin Co., Ltd. Crystal Resin II super clear) before curing is thinly coated on an A4 paper size 2 mm thick acrylic sheet (manufactured by Sumitomo Chemical Co., Ltd. SUM IPEX E), and, the graphene surface of the graphene laminate described above was bonded without air bubbles to a resin adhesive surface. This was held at 50° C. for 48 hours in a 5 atmosphere autoclave (TBR-600 manufactured by Chiyoda Electrical Ltd.) and was fully cured. After allowing the cured product to cool naturally to room temperature, the adhesive film was peeled off and a transparent conductive film laminate having high transparency was obtained. The arithmetic mean roughness (Ra) of this transparent conductive film laminate surface was 10 to 20 nm, and it was found that the arithmetic average roughness (Ra) (139 nm) of the rolled copper foil could be significantly greatly improved.

In order to make a comparison with the prior art, an epoxy resin before curing, thinly coated on an A4 size 2 mm thick acrylic sheet is adhered to so that a rolled copper foil formed with the graphene film is on the interior, and a comparison sample with the rolled copper foil removed by etching was prepared after curing. The arithmetic mean roughness (Ra) of surface of this comparison sample was approximately 140 nm, which reflects the arithmetic average roughness (Ra) (139 nm) of the rolled copper foil.

The transparent conductive layer laminate manufactured by transfer and a comparison sample were measured for total light transmittance and haze.

The results are shown in the following table.

TABLE 1

| | Total | |
|---|---|---|
| | light transmittance (%) | Haze (%) |
| acrylic sheet only | 92.7 | 0.37 |
| acrylic sheet coated with epoxy resin | 92.4 | 0.45 |
| transparent conductive film laminate | 81.5 | 1.37 |
| comparison sample | 75.8 | 18.4 |

As can be seen from the table above, compared to the conventional technology the technology of the present invention is a transfer technique that suppresses a reduction in total light transmittance and haze.

### Example 2

The same as in Example 1, after forming a transparent conductive carbon film (graphene film) on the A4 size rolled copper foil, the graphene film was cut out in the shape of an electrode by a cutting process (carried out by Laser Job Ltd.) using an ultraviolet laser.

Next, the same as in Example 1, the graphene film is adhered to the rolled copped foil attached with the graphene film cut into the shape of the electrode, the peeling liner is removed from the A4 size siloxane-based adhesion film so that the graphene film is on the inside. The rolled copper foil is removed by etching in 5 wt % of ferric chloride and thoroughly washed with ion-exchange water. A transparent conductive film laminate with an electrode shape fixed to the adhesion film was obtained by drying the adhesion film with warm-air drier at 50° C. Furthermore, an epoxy resin (Nissin Resin Co., Ltd. Crystal Resin II super clear) before curing is thinly coated on an A4 paper size 2 mm thick acrylic sheet (manufactured by Sumitomo Chemical Co., Ltd. SUM IPEX E), and, the graphene surface of the graphene laminate described above was bonded without air bubbles to a resin adhesive surface. This was held at 50° C. for 48 hours in a 5 atmosphere autoclave (TBR-600 manufactured by Chiyoda Electrical Ltd.) and was fully cured.

After allowing the cured product to cool naturally to room temperature, the adhesive film was peeled off and a touch panel transparent electrode having high transparency was obtained.

### Example 3

The same as in Example 1, a transparent conductive carbon film (graphene film) was formed on the A4 paper size rolled copper foil.

In the present example, A4 paper sixed the siloxane-based adhesion film used in Example 1 was prepared with the peeling liner still adhered. Only the peeling liner was cut using a Graphtec manufactured small cutting machine (Craft ROBO Pro, Microsoft Windows (registered trademark) corresponding cutting software: Cutting Master 2) and only the peeling liner of the electrode part was peeled off from the adhesive sheet. The adhesion surface remaining in an electrode shape was pressed onto the graphene film of the rolled copper foil formed with the graphene film. At this time, pressing was performed at a bonding pressure of 2.04 kgf/cm² using a film bonder (Suntec Co. Ltd. TMS-SAP) so that bubbles do not enter the film (see FIG. 7). The rolled copper foil is removed by etching in 5 wt % of ferric chloride and thoroughly washed with ion-exchange water. After removing the remaining peeling liner, a transparent conductive film laminate with an electrode shape fixed to the adhesion film was obtained by drying the adhesion film in a warm-air drier at 50° C. Furthermore, an epoxy resin (Nissin Resin Co., Ltd. Crystal Resin II super clear) before curing is thinly coated on an A4 paper size 2 mm thick acrylic sheet (manufactured by Sumitomo Chemical Co., Ltd. SUMIPEX E), and, the graphene surface of the graphene laminate described above was bonded without air bubbles to a resin adhesive surface. This was held at 50° C. for 48 hours in a 5 atmosphere autoclave (TBR-600 manufactured by Chiyoda Electrical Ltd.) and was fully cured.

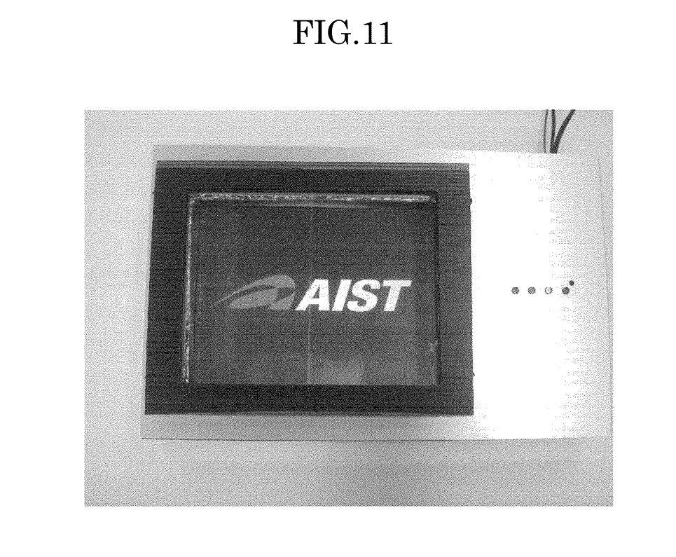

After allowing the cured product to cool naturally to room temperature, the adhesion film was peeled off and a touch panel transparent electrode having high transparency was obtained. A B6 size touch panel was prepared by connecting the patterned touch panel transparent electrodes with the capacitive coupling type touch panel control unit. FIG. 11 is a photograph of the obtained B6 size touch panel.

### Example 4

The same as in Example 1, a transparent conductive carbon film (graphene film) was formed on A4 sized rolled copper foil.

In the present example, an A4 paper size acrylic adhesion film (Optical Adhesion Film OAD01 made by Toyo Packaging Material Ltd, adhesion: 800 gf/25 mm) having the cross-sectional structure shown in FIG. 4 was prepared with the peeling liner still adhered. Only the peeling liner was cut using a Graphtec manufactured small cutting machine (Craft ROBO Pro, Microsoft Windows (registered trademark) corresponding cutting software: Cutting Master 2) and only the peeling liner of the electrode part was peeled off from the adhesive sheet. The adhesion surface remaining in an electrode shape was pressed onto the graphene film of the rolled copper foil formed with the graphene film. At this time, pressing was performed at a bonding pressure of 2.04 kgf/cm² using a film bonder (Suntec Co. Ltd. TMS-SAP) so that bubbles do not enter the film (see FIG. 7). The rolled copper foil is removed by etching in 5 wt % of ferric chloride and thoroughly washed with ion-exchange water. After removing the remaining peeling liner, a transparent conductive film laminate with an electrode shape fixed to the adhesion film was obtained by drying the adhesion film in a warm-air drier at 50° C. Two samples of the touch panel transparent electrode were prepared and each was used as the lower electrode and upper electrode of the capacitance coupling type touch panel. Furthermore, the lower electrode and upper electrode were bonded to an A4 paper size 2 mm thick acrylic sheet (manufactured by Sumitomo Chemical Co., Ltd. SUMIPEX E). At this time, pressing was performed with a bonding pressure of 2.04 kgf/cm² using the film bonder so that air bubbles do not enter. FIG. 10 is a schematic cross-sectional view of a capacitive coupling type touch panel prepared using the present example.

According to the method of the present invention, it is possible to solve the problem of transferring a shape of a surface of a film forming metal substrate to a graphene film which is the problem of a conventional method for forming a binder layer on a graphene film, and form a transparent conductive film laminate with lesser haze and higher transparency.

1. A method for manufacturing a transparent conductive carbon film by forming the transparent conductive carbon film by a CVD method on a film forming substrate and subsequently removing the film forming substrate from the transparent conductive carbon film, the method comprising:
preparing a film having a surface with adhesive strength and bonding a surface with adhesion strength of the film to all or a part of a surface of the transparent conductive carbon film before removing the film forming substrate.

2. The method for manufacturing a transparent conductive carbon film according to claim 1, comprising:
adding pressure to the film after bonding an adhesion surface of the film to the surface of the transparent conductive carbon film.

3. The method for manufacturing a transparent conductive carbon film according to claim 1, comprising:
performing pressing at the same time as bonding the adhesion surface of the film to the surface of the transparent conductive carbon film using a pressure roller.

4. The method for manufacturing a transparent conductive carbon film according to claim 2, comprising:
performing pressing at the same time as bonding the adhesion surface of the film to the surface of the transparent conductive carbon film using a pressure roller.

5. The method for manufacturing a transparent conductive carbon film according to claim 1, comprising:
transferring the transparent conductive carbon film to another transfer material.

6. The method for manufacturing a transparent conductive carbon film according to claim 4, comprising:
transferring the transparent conductive carbon film to another transfer material.

7. The method for manufacturing a transparent conductive carbon film according to claim 1, comprising:
forming the transparent conductive carbon film into a pattern.

8. The method for manufacturing a transparent conductive carbon film according to claim 6, comprising:
forming the transparent conductive carbon film into a pattern.

9. The method for manufacturing a transparent conductive carbon film according to claim 7, wherein the forming into a pattern is performed on the transparent conductive carbon film formed on the film forming substrate using a CVD method.

10. The method for manufacturing a transparent conductive carbon film according to claim 8, wherein the forming into a pattern is performed on the transparent conductive carbon film formed on the film forming substrate using a CVD method.

11. The method for manufacturing a transparent conductive carbon film according to claim 9, wherein the forming into a pattern uses an object having a patterned surface with adhesion strength as the film for bonding.

12. The method for manufacturing a transparent conductive carbon film according to claim 10, wherein the forming into a pattern uses an object having a patterned surface with adhesion strength as the film for bonding.

13. The method for manufacturing a transparent conductive carbon film according to claim 1, wherein the film forming substrate is a copper substrate.

14. The method for manufacturing a transparent conductive carbon film according to claim 12, wherein the film forming substrate is a copper substrate.

15. The method for manufacturing a transparent conductive carbon film according to claim 1, wherein the transparent conductive carbon film is a graphene film.

16. The method for manufacturing a transparent conductive carbon film according to claim 13, wherein the transparent conductive carbon film is a graphene film.

17. A transparent conductive carbon film laminate manufactured using the manufacturing method of the transparent conductive carbon film according to claim 1.
